(19) United States
(12) Patent Application Publication
(10) Pub. No.: US 2022/0147513 A1
(43) Pub. Date: May 12, 2022

(54) CONFIGURING DISTRIBUTED SEQUENTIAL TRANSACTIONAL DATABASES

(71) Applicant: BRITISH TELECOMMUNICATIONS PUBLIC LIMITED COMPANY, LONDON (GB)

(72) Inventors: Jonathan ROSCOE, London (GB); Alexander HEALING, London (GB); Joshua DANIEL, London (GB)

(21) Appl. No.: 17/593,623

(22) PCT Filed: Mar. 18, 2020
(86) PCT No.: PCT/EP2020/057537

§ 371 Date: Sep. 21, 2021

(30) Foreign Application Priority Data
Mar. 23, 2019 (EP) 19164780.9

(51) Int. Cl. G06F 16/23; G06F 16/27

(52) U.S. Cl. CPC G06F 16/2379; G06F 16/27

(57) ABSTRACT

A computer implemented method of configuring a distributed sequential transactional database for a software application operating with the database. The method including receiving a descriptor for the application specifying characteristics of the database required for the application and accessing the databases to determine an extent to which each the database complies with the characteristics in the descriptor. The method further including, responsive to the determination, identifying one or more attributes of the database for adjustment based on the characteristics in the descriptor so as to improve the extent of compliance of the database with the characteristics in the descriptor, the one or more attributes being determined by a machine learning algorithm trained to categorize database characteristics in terms of suitable adjustments, and adjusting the database in accordance with the determined attributes.

### PRIORITY CLAIM

The present application is a National Phase entry of PCT Application No. PCT/EP2020/057537, filed Mar. 18, 2020, which claims priority from EP Patent Application No. 19164780.9, filed Mar. 23, 2019, which is hereby fully incorporated herein by reference.

### TECHNICAL FIELD

The present disclosure relates generally to the configuration of distributed sequential transactional databases for software applications.

### BACKGROUND

Distributed sequential transactional databases such as blockchains are often increasingly employed by a wide and diverse variety of applications ranging from cryptocurrencies, authentication, asset management, interoperation and recording of data by internet-of-things (IoT) devices, and other applications known in the art. Each database can be configured differently according to characteristics including algorithms used, security features, peer-mining characteristics, database size and age, reliability, security, and other characteristics. Typically, a database is used by a particular application based on availability, familiarity or a bespoke or new database is generated. The features of such databases may not reflect the requirements of the particular application. Furthermore, features available in other databases may be underutilized or not put to best effect.

Thus, it would be beneficial to provision distributed sequential transactional databases for applications without the aforementioned disadvantages.

### SUMMARY

According to a first aspect of the present disclosure, there is a provided a computer implemented method of configuring a distributed sequential transactional database for a software application operating with the database. The method includes receiving a descriptor for the application specifying characteristics of the database required for the application and accessing the databases to determine an extent to which each the database complies with the characteristics in the descriptor. The method further including, responsive to the determination, identifying one or more attributes of the database for adjustment based on the characteristics in the descriptor so as to improve the extent of compliance of the database with the characteristics in the descriptor, the one or more attributes being determined by a machine learning algorithm trained to categorize database characteristics in terms of suitable adjustments, and adjusting the database in accordance with the determined attributes.

In embodiments, the accessing and identifying are iterated until a stopping condition is met.

In embodiments, the stopping condition includes the database complying with the characteristics in the descriptor to at least a predetermined threshold extent.

In embodiments, the distributed sequential transactional databases is a blockchain.

In embodiments, the characteristics of the database include one or more of: an algorithm used to validate a proof-of-work of a miner for the database, a format and/or length of an address used for entities transacting in the database, a number of peers in a miner network for the database, a characteristic of a genesis block of the database, a hashpower of the database, a consensus mechanism used for the database, a maximum block time and/or size for the database, an age of the database, a size of the database, a number of blocks of the database, an encryption algorithm or standard used for the database, a peer latency for the database, a transaction security protocol or standard for the database, and a description of the database.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is an arrangement for configuring a distributed sequential transactional database for an application according to embodiments of the present disclosure.

FIG. 3 is an arrangement for training a machine learning algorithm for use with the arrangement of FIG. 2 in accordance with embodiments of the present disclosure.

FIG. 4 is a flowchart of a method for configuring a distributed sequential transactional database for an application according to embodiments of the present disclosure.

### DETAILED DESCRIPTION

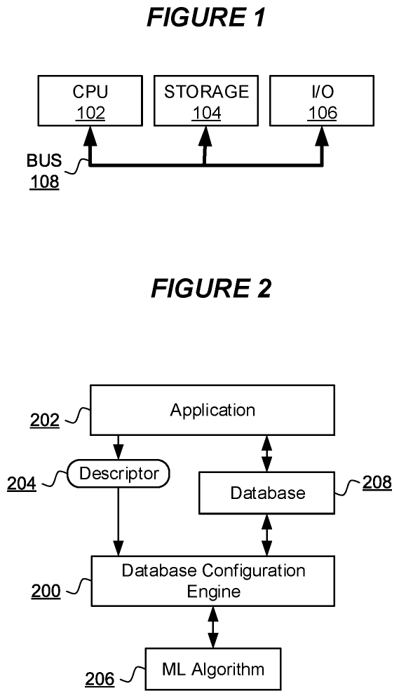

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present disclosure provide for the configuration of a distributed sequential transactional database for a software application 202. A distributed sequential transactional database is a transactional data store that is distributed and shared by multiple entities via a communication network. Distributed sequential transactional databases are well known in the field of cryptocurrencies and are documented, for example, in “Mastering Bitcoin. Unlocking Digital Crypto-Currencies.” (Andreas M. Antonopoulos, O'Reilly Media, April 2014). Thus, an example of such a database is a blockchain database though it will be appreciated that other suitable databases, data structures or mechanisms possessing the characteristics essential for embodiments of the present disclosure could alternatively be used. Typically, a blockchain database is a distributed chain of block data structures accessed by a network of nodes, often referred to as a network of miners. Each block in a blockchain includes a one or more data structures, and in some exemplary blockchains a Merkle tree of hash or digest values for transactions included in a block are used to arrive at a hash value for a block which is itself combined with a hash value for a preceding block to generate a chain of blocks (i.e. a blockchain). A new block of one or more transactions is added to the blockchain by such miner software, hardware, firmware or combination systems in, for example, a miner network. A newly added block constitutes a current state of the blockchain. Such miners undertake validation of substantive content of transactions (such as any criteria defined therein) and adds a block of one or more new transactions to a blockchain as a new blockchain state when a challenge is satisfied as a “proof-of-work”, typically such challenge involving a combination hash or digest for a prospective new block and a preceding block in the blockchain and some challenge criterion. Thus, miners in a miner network may each generate prospective new blocks for addition to the blockchain. Where a miner satisfies or solves a challenge and validates the transactions in a prospective new block such new block is added to the blockchain. Accordingly, a blockchain provides a distributed mechanism for reliably verifying a data entity such as an entity constituting or representing the potential to consume a resource.

FIG. 2 is an arrangement for configuring a distributed sequential transactional database for an application 202 according to embodiments of the present disclosure. The application includes, but is not necessarily exclusively, a software component desirous or requiring access to and/or services of a distributed sequential transactional database 208 such as a blockchain database. The application 202 thus operates with the database 208 through, for example, a database connector, protocol or other suitable means as will be apparent to those skilled in the art. The application 202 generates, provides, and/or communicates a descriptor 204 as a data structure, file or data stream. The descriptor 204 includes a specification of characteristics of a database required by the application 202 for its operation. Such characteristics can include one or more of, inter alia: an algorithm used to validate a proof-of-work of a miner for the database; a format and/or length of an address used for entities transacting in the database; a number of peers in a miner network for the database; a characteristic of a genesis block of the database; a hashpower of the database; a consensus mechanism used for the database; a maximum block time and/or size for the database; an age of the database; a size of the database; a number of blocks of the database; an encryption algorithm or standard used for the database; a peer latency for the database; a transaction security protocol or standard for the database; a description of the database; and/or other characteristics of a distributed sequential transactional database as will be apparent to those skilled in the art.

A database configuration engine 200 is a hardware, software, firmware or combination component operable to provide configuration services in respect of the database 208 for the application 202 as described below. The engine 200 receives or accesses the descriptor 204 for the application 202. The engine 200 performs an identification of characteristics of the database 208 by accessing the database 208. The identification of characteristics can include, for example, accessing a descriptor, configuration, or information source detailing configuration characteristics for the database 208 such as algorithms used by the database or the like. Such algorithms can include, for example, encryption, hashing, security, proof-of-work or other algorithms used by the database 208. Additionally, and/or alternatively the engine 200 identifies characteristics of the database 208 through operations performed with the database such as the storage, retrieval or monitoring of the database 208. Such operations can determine, for example, a response time, a peer latency, a block size, a proof-of-work timeframe, a number of peers or other characteristics of the database 208 obtainable or discernible through interoperation with the database 208 as will be apparent to those skilled in the art. Thus, in these ways, the engine 200 is operable to determine an extent to which the database 208 complies with the required characteristics specified in the descriptor 204. The extent of compliance can be represented numerically, such as by reference to a proportion or number of characteristics complied with, or through a characteristic compliance representation such as a vector representation with elements in the vector representing characteristics and compliance being indicated by predetermined values or ranges of values indicated in, or in association with, the vector elements. Subsequently, the engine 200 identifies one or more attributes of the database 208 for adjustment so as to improve the extent of compliance of the database 208 with the characteristics in the descriptor 204. The process of determining an extent of compliance of the database 208 and adjusting attributes of the database 208 to improve compliance can occur iteratively until a stopping condition is met. Such a stopping condition can include, for example, an extent of compliance of the database 208 meeting a threshold extent of compliance.

A machine learning algorithm 206 is provided such as an autoencoder-based machine learning facility for use by the engine 200 in identifying one or more attributes of the database 208 for adjustment to improve an extent of compliance of the database 208 with the characteristics in the descriptor 204. For example, the machine learning algorithm 206 is trained to classify one or more characteristics of a database 208 for which improvement of adjustment is required into one or more adjustments of attributes of the database 208. Additionally or alternatively, the machine learning algorithm 206 can be trained to classify inputs including a characterization of a current configuration of the database 208 and a desired characteristic change so as to identify appropriate attribute adjustments for the database 208 to achieve an improved extent of compliance by the database 208.

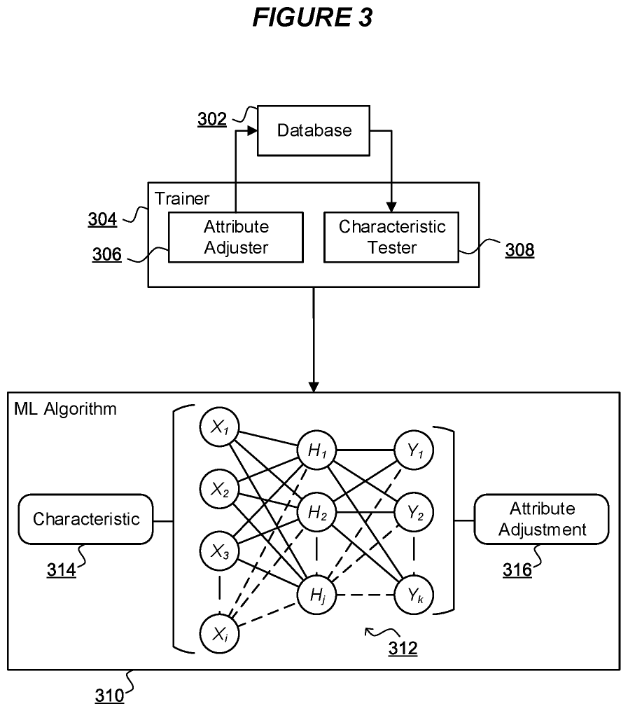

FIG. 3 is an arrangement for training a machine learning algorithm for use with the arrangement of FIG. 2 in accordance with embodiments of the present disclosure. The arrangement of FIG. 3 is purely exemplary and many other techniques to training machine learning algorithms could be employed as will be apparent to those skilled in the art. The arrangement of FIG. 3 illustrates a trainer component 304 as a hardware, software, firmware or combination component for training a machine learning algorithm 310 to classify inputs to determine attribute adjustments for the database 208 to improve an extent of compliance of the database 208 with characteristics in the descriptor 204. In the illustrative algorithm 310 of FIG. 3, an autoencoder 312 is provided accepting inputs as characteristics 314 so as to classify the characteristics as one or more attribute adjustments 316. The algorithm 310 is trained, for example, using supervised training techniques employing backpropagation. Thus, the trainer 304 accesses a distributed sequential transactional database 302 that may be different to the database 208 used in production, such as one or more dedicated training databases 302. The trainer 304 performs a series of adjustments to configuration attributes of the database 302 by way of an attribute adjuster 306. Such attributes and their adjustments can be indicated, specified or selected from a registry of such adjustments. Further, on conclusion of an attribute adjustment, the trainer 304 determines an extent to which the database complies with each of one or more characteristics by way of a characteristic tester 308. Such identification of compliance can be performed as previously described above with respect to FIG. 2. Thus, the trainer 304 is arranged to select attribute adjustments and to determine characteristic changes of the training database 302. The adjustments and characteristic change determination is repeated multiple times iteratively such that each attribute/characteristic pair (or attribute set/characteristic set pair) constitutes a training example for supervised training of the machine learning algorithm 310. Thus, in this way the machine learning algorithm 310 is trained to categorize desired characteristics 314 as one or more attribute adjustments 316.

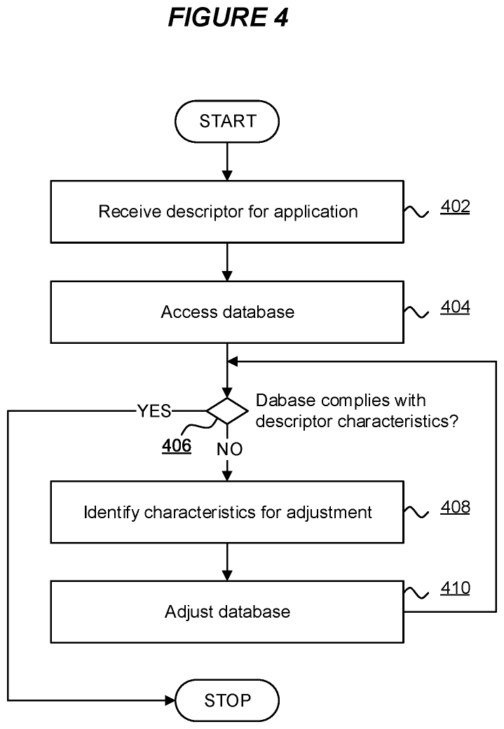

FIG. 4 is a flowchart of a method for configuring a distributed sequential transactional database 208 for an application 202 according to embodiments of the present disclosure. Initially, at 402, the method receives a descriptor 204 for the application 202 specifying characteristics of the database 208 required for the application 202. At 404 the method accesses the database 208 and at 406 the method determines an extent to which the database complies with the characteristics in the descriptor. If the database 208 complies with the descriptor characteristics to a suitable extent (such as an extent meeting a predetermined threshold extent), the method concludes. Otherwise, the method proceeds to 408 where characteristics of the database 208 for adjustment are identified by way of the machine learning algorithm 206. At 410 the identified characteristics for adjustment are adjusted in the database 208 and the method iterates to 406 to reassess the extent of compliance of the database 208. Notably, in some embodiments, other stopping conditions for the iteration from 410 can be employed such as a threshold number of iterations of the like.

Insofar as embodiments of the present disclosure are described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the present disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of configuring a distributed sequential transactional database for a software application operating with the distributed sequential transactional database, the method comprising:
receiving a descriptor for the software application specifying characteristics of the distributed sequential transactional database required for the software application;
accessing the distributed sequential transactional database to determine an extent to which the distributed sequential transactional database complies with the characteristics in the descriptor;
responsive to the determination, identifying one or more attributes of the distributed sequential transactional database for adjustment based on the characteristics in the descriptor so as to improve the extent of compliance of the distributed sequential transactional database with the characteristics in the descriptor, the one or more attributes being determined by a machine learning algorithm trained to categorize database characteristics in terms of suitable adjustments;
adjusting the distributed sequential transactional database in accordance with the one or more attributes.

2. The method of claim 1 wherein the accessing and identifying steps are iterated until a stopping condition is met.

3. The method of claim 2 wherein the stopping condition includes the distributed sequential transactional database complying with the characteristics in the descriptor to at least a predetermined threshold extent.

4. The method of claim 1 wherein the distributed sequential transactional database is a blockchain.

5. The method of claim 1 wherein the characteristics of the distributed sequential transactional database include one or more of: an algorithm used to validate a proof-of-work of a miner for the distributed sequential transactional database; a format and/or length of an address used for entities transacting in the distributed sequential transactional database; a number of peers in a miner network for the distributed sequential transactional database; a characteristic of a genesis block of the distributed sequential transactional database; a hashpower of the distributed sequential transactional database; a consensus mechanism used for the distributed sequential transactional database; a maximum block time and/or size for the distributed sequential transactional database; an age of the distributed sequential transactional database; a size of the distributed sequential transactional database; a number of blocks of the distributed sequential transactional database; an encryption algorithm or standard used for the distributed sequential transactional database; a peer latency for the distributed sequential transactional database; a transaction security protocol or standard for the distributed sequential transactional database; and a description of the distributed sequential transactional database.

6. A computer system including a processor and memory storing computer program code for performing the method of claim 1.

7. A computer program element comprising computer program code to, when loaded into a computer system and executed thereon, cause the computer to perform the method of claim 1.
